(19) United States
(12) Patent Application Publication
(10) Pub. No.: US 2026/0201740 A1
(43) Pub. Date: Jul. 16, 2026

(54) SYSTEMS AND METHODS FOR OBSTRUCTION DETECTION AND ACCESS CONTROL

(71) Applicant: THE CHAMBERLAIN GROUP LLC, OAK BROOK, IL (US)

(72) Inventor: Michael J. Davies, Woodridge, IL (US)

(21) Appl. No.: 19/021,846

(22) Filed: Jan. 15, 2025

(51) Int. Cl. E05F 15/40; G05D 3/12

(52) U.S. Cl. CPC E05F 15/40; G05D 3/12; E05Y 2900/106

(57) ABSTRACT

An obstruction detection system for an access point of a secured area is disclosed. The system can obtain, from an optical rangefinder, a distance from the optical rangefinder to an object at the access point. The system can transmit, to a moveable barrier operator for controlling a moveable barrier configured to manage access to the secured area, at least one of: the distance, a control instruction for controlling a moveable barrier, or an indication that the distance falls within a target range of distances associated with the secured area. The system can generate an instruction for modifying a state of the moveable barrier, based on transmitting the at least one of the distance, the control instruction, or the indication.

### TECHNICAL FIELD

This disclosure relates to obstruction detection and, more specifically, to using moveable barrier operator systems and methods to avoid obstructions.

### BACKGROUND

Moveable barrier operators can control moveable barriers in, for example, garages, secure areas, and gated zones in response to received signals from transmitters. The moveable barrier operators control the moveable barriers in response to signals from sensors. However, traditional systems for managing barrier operators have challenges, such as problems related to avoiding obstructions.

### SUMMARY

Aspects and advantages of the invention in accordance with the present disclosure will be set forth in part in the following description, or may be obvious from the description, or may be learned through practice of the technology.

In accordance with an embodiment, an obstruction avoidance system for an access point of a secured area is provided. The system includes an optical rangefinder configured to determine distances of objects from the optical rangefinder, wherein the optical rangefinder is positioned to obtain the distances for the objects at the access point for the secured area. The system also includes a controller configured to execute instructions that cause the system to perform operations. The operations include obtaining, from the optical rangefinder, a distance from the optical rangefinder to a first object at the access point. The operations include transmitting, to a moveable barrier operator for controlling a moveable barrier configured to manage access to the secured area, at least one of: the distance; a control instruction for controlling a moveable barrier; or an indication that the distance falls within a target range of distances associated with the secured area. The operations include generating, based on transmitting the at least one of the distance, the control instruction, or the indication, an instruction for modifying a state of the moveable barrier.

In accordance with another embodiment, a method for managing obstruction detection for an access point of a secured area is provided. The method includes obtaining, from an optical rangefinder, a distance from the optical rangefinder to a first object at the access point. The method includes transmitting, to a moveable barrier operator for controlling a moveable barrier configured to manage access to the secured area, the distance. The method includes generating, based on transmitting the distance, an instruction for modifying a state of the moveable barrier.

In accordance with another embodiment, provided is a non-transitory computer-readable medium storing instructions which, when executed by a hardware processor, are configured to: obtain, from an optical rangefinder, a plurality of distances from the optical rangefinder to a first object at an access point; determine, based on the plurality of distances, a length of time for which the first object is at the distance from the optical rangefinder; determine that the length of time exceeds a threshold duration; determine that the first object intersects a beam of the optical rangefinder; transmit, to a moveable barrier operator for controlling a moveable barrier configured to manage access to a secured area, an indication of one or more of the plurality of distances and the length of time; determine that the distance falls within a target range of distances associated with the secured area; and generate, based on determining that the first object intersects a beam of the optical rangefinder and that the distance falls within a target range of distances associated with the secured area, an instruction for modifying a state of the moveable barrier.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

FIG. 1 shows an example moveable barrier operator system for operating a movable barrier, in accordance with some embodiments.

FIG. 2 shows an example analysis system that includes an obstruction detection system, according to some embodiments.

FIG. 3 shows an exemplary process of accessing a trained machine learning model, according to some embodiments.

FIG. 4 shows an example method that can be performed by a system described herein, according to some embodiments.

FIG. 5 is a block diagram that illustrates an example computer system, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions, operations and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Embodiments described herein relate to obstruction detection systems for an access point of a secured area. The system can include an optical rangefinder that can determine distances of objects from the optical rangefinder. The optical rangefinder can be positioned to obtain distances for objects at or near an access point for a secured area. The system can use the optical rangefinder to obtain one or more distances from the optical rangefinder to one or more objects at the access point. The system can transmit at least one of the one or more distances, a control instruction for controlling a moveable barrier, and/or an indication that the one or more distances fall within a target range of distances associated with the secured area. The system may transmit this/these to a moveable barrier operator for controlling the moveable barrier configured to manage access to the secured area. The system can generate an instruction for modifying a state of the moveable barrier. The modified state of the moveable barrier may stop or alter the direction of travel of a barrier to avoid an obstruction.

Optical (e.g., laser- and/or LED-based) time-of-flight distance measurement systems can be effective at detecting the presence and/or distance of objects from the system. This technology can be valuable as a retro-reflective photo eye for obstruction detection in the path of a moveable barrier operator. Existing retro-reflective photo-eyes generally have a relatively narrow field of view. Additionally or alternatively, these systems can be difficult to align during installation. These photo-eyes can become misaligned without indication, posing reliability concerns to moveable barrier operator systems.

Using laser time-of-flight technology in these systems can reduce the need for a reflector and/or regular alignment. For example, if a laser rangefinder is pointed in the general direction of an object, it will work to detect obstructions relating to the object. This can be done without alignment of a reflector in some embodiments. For example, the rangefinder may be configured to generate a beam that is parallel to a ground (e.g., with a garage door).

Traditional systems require alignment of a beam in a very specific plane. By contrast, certain embodiments herein can allow a laser time-of-flight to work pointed in any direction (e.g., angle). The system would need to be installed correctly and tested by the installer to insure it is protecting the path of interest. The system would then need to learn this distance as normal and sense deviations from this initial installed distance as faults or obstructions.

Laser-based time-of-flight obstruction sensors can additionally or alternatively provide a moveable barrier operator information on where the obstruction is relative to the sensor. For example, the obstruction sensor can identify the distance of an object from the sensor. This can be helpful when troubleshooting because the moveable barrier operator may be investigated to determine where problems may have arisen.

The rangefinder can include an emitter that sends a pulse of light or a continuous beam of light. The light can reflect off one or more distant objects and return to a detector in the rangefinder. The detector can have a sensor that can capture a time it took for the light to bounce back and calculate the distance an object is from the sensor. The laser can have a beam with a small angle of divergence. For example, the beam of the optical rangefinder has a beam divergence of less than 1 degree. In some embodiments, the divergence of the beam is less than about 0.1 degrees. In some embodiments, a wider angle light source (e.g., divergence of at least about 5 degrees, at least about 10 degrees) may have be used. A wider angle light source can have benefits, including obtaining multiple reflections from multiple objects that can be observed by the detector. Additionally or alternatively, in some embodiments, the system may learn when and/or where one or more objects are expected to be relative to the rangefinder. Thus, the system may be able to detect deviations from an expected position of the one or more objects and use the detected deviations to detect changes in the environment or obstructions and/or modify a position of a moveable barrier to avoid contact with an obstruction.

A laser rangefinder can include a device that measures the distance to an object by emitting a laser beam and calculating the time it takes for the beam to reflect off the object and return to the device. The rangefinder can emit a short pulse of laser light toward a target object. The laser beam reflects off the target object (e.g., a person, a vehicle, and/or other object). The reflected light returns to the rangefinder, where a detector senses the returning signal. The rangefinder can calculate the time taken for the laser to travel to the object and back. Using the known speed of light, the system can compute the distance to the object. Laser rangefinders can be included in a moveable barrier operator (e.g., garage door operator) to enhance safety by preventing entrapment or contact with an obstruction. Entrapment occurs when an object or person is caught or trapped between a movable barrier and other objects within the immediate vicinity of the movable barrier. For example, entrapment describes a condition when an object is caught or held in a position that increases the risk of injury. Traditionally, movable barriers have used mechanical sensors or photoelectric sensors to detect obstructions, but a laser rangefinder can provide a more accurate and intelligent safety mechanism.

The laser rangefinder can be mounted on fixed objects near the movable barrier or to the movable barrier itself. It continuously monitors the space around the moving barrier within its field of view. In some embodiments, the laser rangefinder can emit pulses toward the ground and/or area beneath the barrier. This may occur when the movable barrier is in motion or stopped. For example, as the movable barrier closes, the rangefinder can measure the distance between the rangefinder (e.g., door, door frame, gate) and a wall or floor. If the rangefinder detects an unexpected reduction in distance (e.g., if an object or person is in the path of the barrier), the detection can signal the movable barrier operator to stop and/or reverse the barrier movement, preventing entrapment or contact with an obstruction.

Unlike systems that rely on contact or fixed light beams (e.g., photoelectric sensors), laser rangefinders can offer continuous distance measurements. This can allow the movable barrier operator to slow down if an object is detected near the closing path, fully and/or partially stop and/or reverse if the barrier is approaching too close to the object, and/or resume normal operation once the object is no longer present.

In some embodiments, the laser rangefinder can scan across multiple angles and/or directions, allowing it to detect objects in a broader area compared to single-beam photo sensors. For example, the rangefinder may monitor horizontal (e.g., side to side) and/or vertical (e.g., up and down) directions, detecting objects like bikes, toys, pets, and/or children, even when they are not directly under the movable barrier or otherwise in the path of the movable barrier.

In some embodiments, the laser rangefinder can adapt to different conditions. For example, the rangefinder may distinguish between objects of different sizes and/or detect a speed (e.g., slow-moving, fast-moving) of an object (e.g., a person walking underneath). Based on the size and/or speed of the object, the system can determine whether to modify the movement of the movable barrier. For example, if the system detects the object in the beam path and determines that the object is moving outside the range of the barrier, the system may determine to continue to let the movable barrier along its previous trajectory (e.g., continue to close the barrier). Additionally or alternatively, compared to alternative systems, embodiments described herein can measure a distance and/or speed of the object(s) with an accuracy that reduces the likelihood of false positives (e.g., where the movable barrier reverses without a real object, which may be triggered by dust, sunlight, and/or other visual artifacts) and/or false negatives (e.g., where the object is not detected). Additionally or alternatively, systems described herein may not require physical contact with the object to determine whether to modify a trajectory of the barrier. This can enhance safety and/or reliability of the system.

In some embodiments, the system can be programmed to detect objects of different sizes and/or distances. This may allow for a more targeted benefit for moveable barrier operators. For example, the system may stop a movable barrier for smaller objects (e.g., toys) close to the ground and/or taller objects (e.g., a person) in the barrier's path.

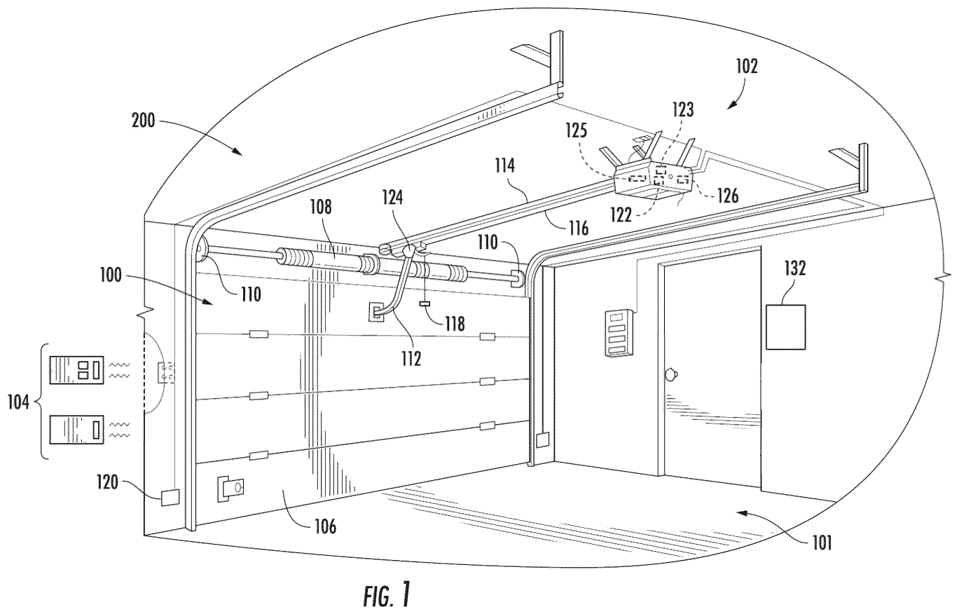

The rangefinder can be integrated with the movable barrier's motor and control system (see FIG. 1). When an obstacle is detected, the control system can modify the motor's behavior, for example, to stop the barrier's motion, reverse the barrier's direction, send an alert to a user (e.g., via a smartphone app or a sound alarm) if a detection is made. Real-time distance and/or speed feedback can allow the system to react quickly, increasing the chance that the barrier stops and/or reverses motion before an entrapment or obstruction incident occurs.

Referring now to FIG. 1, an analysis system 200 is provided that includes a moveable barrier operator system 100 for operating a moveable barrier, such as a garage door 106, that limits access to a secured area, such as a garage 101. In one embodiment, the moveable barrier operator system 100 includes a moveable barrier operator, such as a garage door operator 102, and one or more remote controls such as a transmitter 104. The one or more remote controls may also include, for example, a user device such as a smartphone, a laptop computer, a tablet computer, a wearable device, an in-vehicle device such as an infotainment system coupled to an in-vehicle transmitter, a keypad external to the garage 101, a wall control, a visor-mounted remote control, and/or a handheld transmitter such as a key fob. The garage door operator 102 includes an electric motor 122, communication circuitry 123, and a control circuit (including a processor 125 and a memory 126). The processor 125 may include, for example, a microprocessor, a system-on-a-chip, an application specific integrated circuit (ASIC), and/or a field programmable gate array (FPGA). The processor 125 can be one processor or a plurality of processors that are operatively connected. The memory 126 may include, for example, an electrical charge-based storage media such as EEPROM or RAM, or other non-transitory computer readable media such as an optical or magnetic-based storage device. The memory 126 can store information that can be accessed by the processor 125. For instance, the memory 126 (e.g., one or more non-transitory computer-readable storage mediums, memory devices) can include computer-readable instructions that can be executed by the processor 125. The instructions can be software, firmware, or both written in any suitable programming language or can be implemented in firmware or hardware. Additionally, or alternatively, the instructions can be executed in logically and/or virtually separate threads on processor 125. For example, the memory 126 can store instructions that when executed by the processor 125 cause the processor 125 to perform operations such as any of the operations and functions as described herein.

In some embodiments, the movable barrier operator 102 includes a rail 116 and drive member 114 such as a chain, belt, or screw driven by the motor 122 relative to the rail 116. The electric motor 122 in cooperation with the drive member 114 is operable to move the movable barrier 106 between open and closed positions. For example, a trolley 124 is coupled to the drive member 114 as well as an arm 112 that is attached to the movable barrier 106. The motor 122 shifts the trolley 124 back-and-forth along the rail 116 to lift and lower the movable barrier 106. A release mechanism 118 is coupled to the trolley 124 to allow the movable barrier 106 to be disconnected from the movable barrier operator 102 for manual operation such as during a power failure.

The moveable barrier operator system 100 includes a drum and cable mechanism 110 that is attached to the movable barrier 106. The drum and cable mechanism 110 includes a drum and a corresponding cable on each side of the movable barrier 106. The cable is paid out from and wound up onto the drum when the movable barrier 106 is respectively lowered and raised. The drum and cable mechanism 110 couples to a counterbalance such as a torsion spring 108 that assists in lifting the weight of the movable barrier 106 and enables the movable barrier operator 102 to open or close the movable barrier 106 via movement of the trolley 124. In some embodiments, an optical device such as a photo eye system 120 senses an obstruction (e.g. object and/or a human) that may be in the path of the movable barrier 106 as the movable barrier 106 closes.

With continued reference to FIG. 1, the analysis system 200 may include an imaging system 132 in the secured area. The imaging system 132 may facilitate communication between the movable barrier operator 102, photo eye system 120, transmitter 104, and/or a remote resource such as a server computer. The imaging system 132 can include one or more imagers configured to image objects, such as objects within the garage 101. For example, the imaging system 132 may generate images of one or more objects within the garage 101. The imaging system 132 may be permanently installed in the garage 101. However, in some embodiments, the imaging system 132 can be a mobile device (e.g., a smart device) associated with a user. In some embodiments, the imaging system 132 can be configured to transmit obtained images to another device, such as a computing device (e.g., to an obstruction detection system 205).

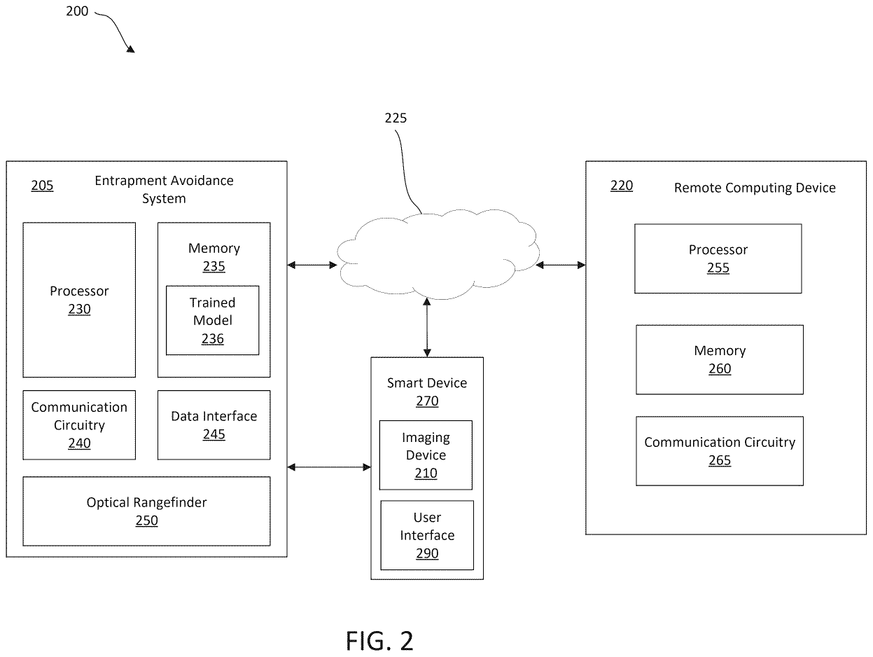

FIG. 2 shows an example analysis system 200 that includes an obstruction detection system 205, according to some embodiments. The analysis system 200 can include an obstruction detection system 205, a remote computing device 220, a smart device 270, and/or a network 225. The obstruction detection system 205 communicates with a remote computing device 220 over a network 225. The network 225 may include, as examples, the internet, a Wi-Fi network, wired network/interface, and/or a cellular network. As an example, the obstruction detection system 205 communicates over the internet via a Wi-Fi network, such as a Wi-Fi network of a home or a (e.g., the garage 101). In another example, the obstruction detection system 205 communicates over the internet via wired connection, for example, an ethernet connection.

The obstruction detection system 205 includes a processor circuitry 230 operably coupled to a memory 235, communication circuitry 240, a data interface 245, and an optical rangefinder 250. The memory 235 may be configured to store a trained model 236 and/or associated data/algorithms. The obstruction detection system 205 may include and/or be in communication with one or more cameras, such as an imaging device 210 of the smart device 270. The processor circuitry 230 can be configured to operate and control the data interface 245, an associated camera, and/or the trained model 236.

The optical rangefinder 250 can determine distances of objects from the optical rangefinder. The optical rangefinder 250 may be positioned to obtain distances for objects at or near an access point for a secured area. The optical rangefinder 250 can measure one or more angles, times-of-flight, and/or parallaxes to compute the distances. For example, the optical rangefinder 250 can use a triangulation principle by, for example, separating a plurality (e.g., two) optical windows and/or lenses by a fixed baseline. Each lens can project an image of a target onto a combined viewing screen. The optical rangefinder 250 may align one or more images of the target, which may generate a distance. In some embodiments, the optical rangefinder 250 rangefinder can emit a laser and/or LED pulse toward the target and measure the time it takes for the light to return. The distance may be calculated using the formula:

$$d = \frac{c t}{2}$$

where c is the speed of light and t is the measured time interval. In some embodiments, the optical rangefinder 250 may generate a continuous wave (e.g., a laser) that is modulated and emitted toward the target. Reflected light can be phase-shifted (e.g., modified modulation cycle), which can indicate the distance based on the extent of the shift of the phase. Additionally or alternatively, the optical rangefinder 250 may generate imagery from the object at a plurality of perspectives and, based on an analysis of parallax (e.g., shift in the position of the object between images), can compute the distance. The obstruction detection system 205 may determine that the object intersects a beam of the optical rangefinder 250.

In some embodiments, the optical rangefinder 250 can generate a beam that has a small beam divergence. For example, in some embodiments, the beam divergence may be less than about 0.1 degrees, about 0.2 degrees, about 0.5 degrees, about 1 degree, about 2 degrees, about 5 degrees, about 10 degrees, any value therein, or fall within any range having endpoints therein.

In some embodiments, the obstruction detection system 205 can be configured to obtain (e.g., from the optical rangefinder 250) a distance from the optical rangefinder to one or more objects at or near the access point. The optical rangefinder 250 can transmit (e.g., to a moveable barrier operator) at least one of the distance(s), a control instruction for controlling a moveable barrier, and/or an indication that one or more of the distances fall within a target range of distances associated with a secured area. The moveable barrier operator can control the moveable barrier, which can manage access to the secured area.

The obstruction detection system 205 can generate (e.g., based on transmitting at least one of the distance, the control instruction, and/or the indication) an instruction for modifying a state of the moveable barrier. For example, the obstruction detection system 205 can cause the moveable barrier to open, to close, to change direction, to stop moving, and/or otherwise modify its state. In some embodiments, the obstruction detection system 205 can determine that the one or more distances fall within a target range of distances associated with the secured area. The target range can extend about 0.25 m, about 0.5 m, about 1 m, about 1.5 m, about 2 m, about 3 m, about 5 m, about 10 m, about 15 m, about 20 m, about 25 m, any value therein, or fall within any range having endpoints therein. Additionally or alternatively, the obstruction detection system 205 can obtain (e.g., from the obstruction detection system 205) one or more additional distances from the obstruction detection system 205 to a second object at the access point. The obstruction detection system 205 can determine that the additional distance(s) fall within a second target range of distances associated with the secured area. In some embodiments, a plurality of moveable barriers may be included, each of which can control access to the secured area. Each of the moveable barriers may have a respective target range associated with the obstruction detection system 205. The obstruction detection system 205 can include a plurality of optical rangefinders 250, one or more of which may have respective target ranges associated with the secured area. It may be possible, for example, for an object to be within a first target range but not within a second target range. This may cause the obstruction detection system 205 to modify a state of (e.g., open) a first moveable barrier while maintaining a state of (e.g., keep closed) a second moveable barrier. Thus, the optical rangefinder 250 may be configured to track objects at a plurality of access points of a secured area. This may reduce a need for optical sensors to be present at each access point.

It may be beneficial to determine whether an object is moving or stationary. In some embodiments, the optical rangefinder 250 can obtain a plurality of distances of an object at the access point. The obstruction detection system 205 can determine, based on the plurality of distances, a length of time for which the first object is at the distance from the optical rangefinder 250. In some embodiments, the obstruction detection system 205 can determine that the length of time exceeds a threshold duration. Additionally or alternatively the obstruction detection system 205 can generate (e.g., based on determining that the length of time exceeds a threshold duration) alert data configured to indicate that the length of time exceeds the threshold duration. The alert data may be transmitted to another computing device, such as the smart device 270 and/or the remote computing device 220. The threshold length of time can be about 0.1 s, about 0.2 s, about 0.5 s, about 1 s, about 2 s, about 3 s, about 5 s, about 10 s, about 15 s, about 20 s, about 30 s, about 1 min, about 5 min, any value therein, or fall within any range having endpoints therein.

Prediction and/or expectation of object detection may be valuable for obstruction detection systems. This may be particularly helpful in reducing false positives and/or false negatives. For example, in some embodiments, the obstruction detection system 205 may be configured to determine other characteristics of the object(s), such as a color of the object, a time of day associated with the object intersecting the beam of the optical rangefinder 250, and/or a duration associated with how long the object intersects the beam of the optical rangefinder 250. Using this information, the obstruction detection system 205 may determine that the object is not expected to intersect the beam of the optical rangefinder at a particular time and/or location. The obstruction detection system 205 may generate one or more instructions for modifying the state of the moveable barrier based on the determination that the object is not expected to intersect the beam of the optical rangefinder at a particular time and/or location.

The processor 230 can be configured to communicate with remote devices such as the remote computing device 220 via the communication circuitry 240. The communication circuitry 240 may be configured to receive requests to train and/or retrain the trained model 236, and/or draw inferences from the trained model 236. The communication circuitry 240 may cause the data interface 245 to receive data to and/or transmit data from one or more of the smart device 270 and/or the remote computing device 220, such as via the network 225. In some embodiments, the data interface 245 may communicate directly with the smart device 270 and/or the remote computing device 220.

The processor circuitry 230 may cause (e.g., send instructions to) the imaging device 210 to capture images upon the data interface 245 changing the state of the movable barrier 204. The processor 230 may receive the images from the imaging device 210 and cause the captured image(s) to be stored (e.g., in memory 235 or remotely) and/or process them.

The communication circuitry 240 can communicate with remote devices such as the remote computing device 220, peripheral devices, and remote controls using wired and/or wireless protocols. In embodiments where the imaging device 210 is separate from the obstruction detection system 205, the communication circuitry 240 may be configured to communicate with the imaging device 210 directly or via network 225 and remote computing device 220. The obstruction detection system 205 may control when the imaging device 210 captures images and may receive images captured by the imaging device 210 and store the images in memory, e.g., memory 235. The communication circuitry 240 may communicate with the imaging device 210 via a wired or wireless connection, for example, one or more of power line communication, ethernet, Wi-Fi, Bluetooth, Near Field Communication (NFC), Zigbee, Z-Wave and the like.

The remote computing device 220 includes a processor 255, memory 260, and communication circuitry 265. The processor 255 is in communication with the memory 260 and communication circuitry 265. The remote computing device 220 may include one or more remote computing devices, such as server computers, user devices (e.g., laptops, smart devices, other user interfaces, etc.), and/or devices disposed in a remote location from the obstruction detection system 205. The remote computing device 220 is configured to communicate with the obstruction detection system 205 via the network 225. The memory 260 of the remote computing device 220 may store one or more algorithms for processing images captured by the imaging device 210 and/or stored in memory 260. In some embodiments, the memory 235 additionally or alternatively includes such algorithms.

For example, the memory 235 may store data and/or algorithms configured to control and/or generate the trained model 236. The memory 235 may be configured to store one or more layers for a convoluted neural network (CNN), such as those in the layered input 604 described below.

The smart device 270 includes a processor 275, memory 280, communication circuitry 285, and a user interface 290. The smart device 270 may include, as examples, a smartphone, smartwatch, wearable device, and tablet computer or personal computer. In some embodiments, the obstruction detection system 205 (e.g., the smart device 270) can capture images of objects at different times and/or locations. The user interface 290 may be configured to receive a user input that causes the smart device 270 to carry out one or more commands described herein. The user interface 290 may include, for example, at least one of a touchscreen, a microphone, a mouse, a keyboard, a speaker, an augmented reality interface, or a combination thereof. The processor of the smart device 270 may instantiate one or more applications, for example, a client application for controlling the obstruction detection system 205 and/or the imaging device 210. The smart device 270 may communicate with the obstruction detection system 205 and/or the remote computing device 220 via associated communication circuitry 240, 265 (and/or via the data interface 245) to carry out requests from a user. The communication circuitry 285 of the smart device 270 may communicate with the obstruction detection system 205 via the network 225 and the remote computing device 220, for example, to send real-world images to the obstruction detection system 205. The smart device 270 may communicate control commands to the obstruction detection system 205 via a remote computing device 220 associated with the instantiated application and/or obstruction detection system 205 or via network 225.

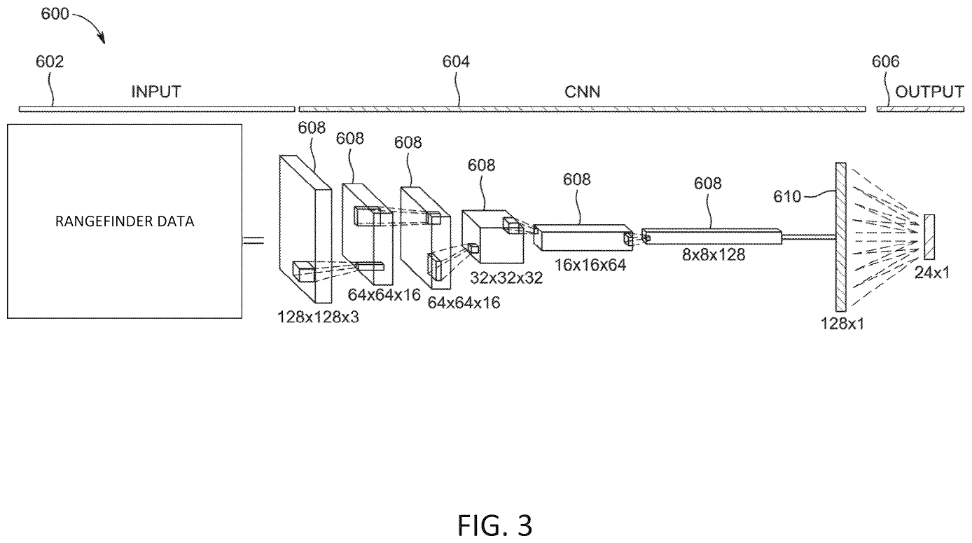

The obstruction detection system 205 may use a trained model to track historical location, time, and/or duration data for use in determining whether inference data obtained by the obstruction detection system 205 is indicative of expected or unexpected data. FIG. 3 shows an exemplary process of accessing a trained machine learning model, according to some embodiments. After images of the samples have been captured as described above, these images may be processed using the trained machine learning model 236. This process may be done automatically in response to receiving the images captured by the image sensor 102.

The process 600 may include receiving an input 602, passing the input 604 through the trained machine learning model 236, for example, a convolutional neural network (CNN), and receiving an output 606. The input 602 may include one or more images, associated times and/or durations, or other tensor data, such as those captured by an imaging device (e.g., the imaging device 210). The trained machine learning model 236 receives the input 602 and passes it to one or more model layers 608. In some examples, the one or more model layers 608 may include hidden layers and a plurality of convolutional layers that “convolve” with a multiplication or other dot product. Additional convolutions may be included, such as pooling layers, fully connected layers, and normalization layers. One or more of these layers may be “hidden” layers because their inputs and outputs are masked by an activation function and a final convolution.

Pooling layers may reduce the dimensions of the data by combining the outputs of neuron clusters at one layer into a single neuron in the next layer. Pooling may be a form of non-linear down sampling. Pooling may compute a max or an average. Thus, pooling may provide a first approximation of a desired feature, such as a predicted device and/or one or more machine vision classifiers. For example, max pooling may use the maximum value from each of a cluster of neurons at a prior layer. By contrast, average pooling may use an average value from one or more clusters of neurons at the prior layer. It may be noted that maximum and average pooling are only examples, as other pooling types may be used. In some examples, the pooling layers transmit pooled data to fully connected layers.

Fully connected layers, such as a fully connected layer 610, may connect every neuron in one layer to every neuron in another layer. Thus, fully connected layers may operate like a multi-layer perceptron neural network (MLP). A resulting flattened matrix may pass through a fully connected layer to classify the input 602.

At one or more convolutions, the process 600 may include a sliding dot product and/or a cross-correlation. Indices of a matrix at one or more convolutions or model layers 608 may be affected by weights in determining a specific index point. For example, each neuron in a neural network may compute an output value by applying a particular function to the input values coming from the receptive field in the previous layer. A vector of weights and/or a bias may determine a function that is applied to the input values. Thus, as the trained machine learning model 236 proceeds through the model layers 608, iterative adjustments to these biases and weights results in a defined output 606, such as a location, orientation, or the like.

Weights may be applied based on one or more factors. For example, the weight of one or more objects and/or one or more layers within a CNN or other machine learning model may be based on data associated with the images. For example, the model layers 608 can apply a weight (e.g., to an image and/or image type) based on an image type, for example, whether the data (e.g., image data) is at a relevant time, for a relevant duration, and/or of a relevant object. For example, a higher weight may be applied to image data obtained at or near a time of inference using the CNN 604. Additionally or alternatively, a lower weight may be given to data obtained in conditions different from those of the inference data.

Additionally or alternatively, a weighting of an image may be based on metadata associated with the image. For example, some metadata may be particularly instructive to the reliability of the image. For example, if the metadata suggest that the image is of above a threshold resolution, above a threshold lighting condition, above a threshold imager quality, within a threshold range of time (e.g., recent enough), within a threshold range of color saturation, within a threshold geographic location (e.g., so as to be from a trustworthy source, suggesting an authentic specimen of the object), within a threshold range of applied filter metrics, within a threshold range of f-stop, and/or other relevant ranges and/or thresholds associated with any metadata listed herein.

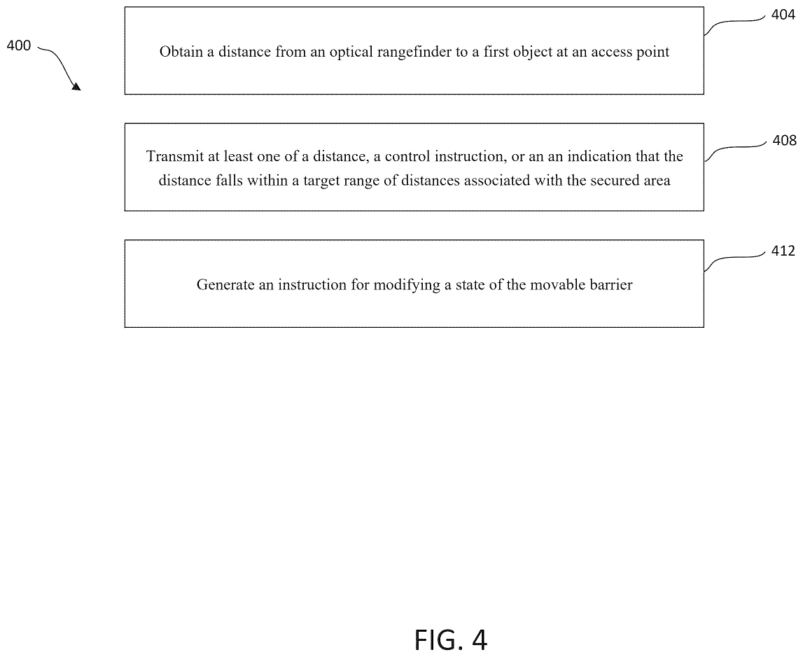

FIG. 4 shows an example method 400 that can be performed by a system described herein, according to some embodiments. The system can include any system described herein, such as the moveable barrier operator system 100, the analysis system 200, the obstruction detection system 205, and/or other system disclosed herein. At block 404 the system can obtain, from an optical rangefinder, a distance from the optical rangefinder to a first object at the access point. The system may determine that the distance falls within the target range of distances associated with the secured area. In some embodiments, the system may obtain a plurality of distances and determine that a plurality of those distances fall within one or more targe ranges of distances associated with the secured area. For example, it may be beneficial to have a single optical rangefinder manage a plurality of access points of a secured area (and/or one or more access points for a plurality of secured areas), each associated with a different moveable barrier. If the system determines that one distance falls within the target range but that a second range does not fall within the target range, then perhaps a state of one moveable barrier is modified while a state of a second moveable barrier is maintained. The system may transmit to a corresponding moveable barrier operator instructions for maintaining or modifying the state of the second moveable barrier.

In some embodiments, the received data may include a length of time for which the first object is at the distance from the optical rangefinder. The metadata can include, for example, an indication of a location, an indication of a rangefinder type (e.g., type or model), an indication of a rangefinder setting, a time associated with when the data was captured, a resolution associated with the data, and/or other relevant metadata. In some embodiments, the system can use the metadata to accurately weight certain data compared to other data in terms of the data's reliability. The system may determine that the length of time exceeds a threshold duration. Additionally or alternatively the system may generate, based on determining that the length of time exceeds a threshold duration, alert data configured to indicate that the length of time exceeds the threshold duration. The alert data may be configured to generate a visual, auditory, haptic, and/or other alert (e.g., at a smart device or other remote computing device).

In some embodiments, the system can determine a characteristic of the first object. The characteristic can include a color of the first object, a time of day associated with the first object intersecting the beam of the optical rangefinder, a duration associated with how long the first object intersects the beam of the optical rangefinder, and/or other feature of the object. The system can determine, based on the characteristic, that the first object is not expected to intersect the beam of the optical rangefinder (e.g., at a particular time, at a particular location). The system may use a convolutional neural network and/or other model to determine that the first object is not expected to intersect the beam of the optical rangefinder. If the system determines that the first object does not currently intersect the beam of the optical rangefinder but is expected to at a time when the moveable barrier may modify its state (e.g., while closing), the system may cause the moveable barrier operator to modify (or maintain) its current state based on this determination. Additionally or alternatively, if the system determines that the first object does currently intersect the beam of the optical rangefinder but is expected not to at a time when the moveable barrier may modify its state (e.g., while closing), the system may cause the moveable barrier operator to maintain (or modify) its current state based on this determination.

At block 408, the system can transmit, to a moveable barrier operator for controlling a moveable barrier configured to manage access to the secured area, various data. The data may include the measured distance, a control instruction for controlling a moveable barrier associated with the moveable barrier operator, and/or an indication that the distance falls within a target range of distances associated with the secured area. At block 412, the system can generate, based on transmitting the at least one of the distance, the control instruction, or the indication, an instruction for modifying a state of the movable barrier.

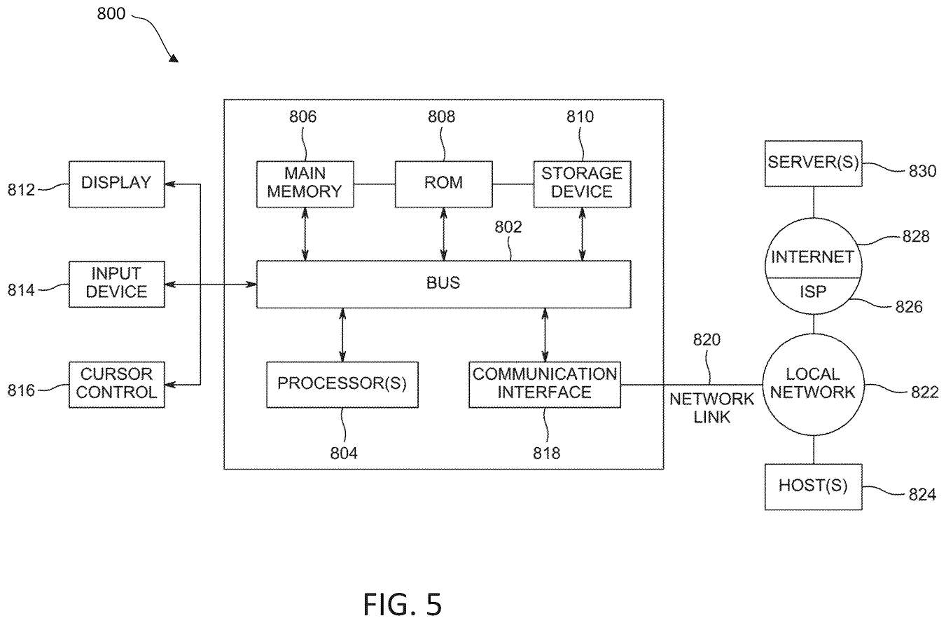

FIG. 5 is a block diagram that illustrates a computer system 800 upon which various embodiments may be implemented. For example, the computer system 800 may be implemented as the data interface 245 (see FIG. 2). The computer system 800 may include a bus 802 or other communication mechanism for communicating information, and a hardware processor, or multiple processors 804 coupled with bus 802 for processing information. The processor(s) 804 may be, for example, one or more general purpose microprocessors.

The computer system 800 also includes a main memory 806, such as a random access memory (RAM), cache and/or other dynamic storage devices, coupled to the bus 802 for storing information and instructions to be executed by the processor 804. The main memory 806 may be used for storing temporary variables or other intermediate information during execution of instructions to be executed by the processor 804. Such instructions, when stored in storage media accessible to the processor 804, render computer system 800 into a special-purpose machine that is customized to perform the operations specified in the instructions.

The computer system 800 further includes a read only memory (ROM) 808 or other static storage device coupled to the bus 802 for storing static information and instructions for the processor 804. A storage device 810, such as a magnetic disk, optical disk, or USB thumb drive (Flash drive), etc., is provided and coupled to bus 802 for storing information and instructions.

The computer system 800 may be coupled via the bus 802 to a display 812, such as a cathode ray tube (CRT) or LCD display (or touch screen), for displaying information to a computer user. An input device 814, including alphanumeric and other keys, is coupled to the bus 802 for communicating information and command selections to the processor 804. Another type of user input device is a cursor control 816, such as a mouse, a trackball, or cursor direction keys for communicating direction information and command selections to the processor 804 and for controlling cursor movement on the display 812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 800 may include a user interface module to implement a GUI that may be stored in a mass storage device as computer executable program instructions that are executed by the computing device(s). The computer system 800 may further, as described below, implement the techniques described herein using customized hard-wired logic, one or more ASICs or FPGAs, firmware and/or program logic which in combination with the computer system causes or programs the computer system 800 to be a special-purpose machine. According to some embodiments, the techniques herein are performed by the computer system 800 in response to the processor(s) 804 executing one or more sequences of one or more computer readable program instructions contained in the main memory 806. Such instructions may be read into the main memory 806 from another storage medium, such as the storage device 810. Execution of the sequences of instructions contained in the main memory 806 causes the processor(s) 804 to perform the process steps described herein. In alternative embodiments, hard-wired circuitry may be used in place of or in combination with software instructions.

Various forms of computer readable storage media may be involved in carrying one or more sequences of one or more computer readable program instructions to processor for execution. For example, the instructions may initially be carried on a magnetic disk or solid state drive of a remote computer. The remote computer may load the instructions into its dynamic memory and send the instructions over a telephone line using a modem. A modem local to the computer system 800 may receive the data on the telephone line and use an infra-red transmitter to convert the data to an infra-red signal. An infra-red detector may receive the data carried in the infra-red signal and appropriate circuitry may place the data on the bus 802. The bus 802 carries the data to the main memory 806, from which the processor 804 retrieves and executes the instructions. The instructions received by the main memory 806 may optionally be stored on the storage device 810 either before or after execution by the processor 804.

The computer system 800 also includes a communication interface 818 coupled to the bus 802. The communication interface 818 provides a two-way data communication coupling to a network link 820 that is connected to a local network 822. For example, the communication interface 818 may be an integrated services digital network (ISDN) card, cable modem, satellite modem, or a modem to provide a data communication connection to a corresponding type of telephone line. As another example, the communication interface 818 may be a local area network (LAN) card to provide a data communication connection to a compatible LAN (or WAN component to communicated with a WAN). Wireless links may also be implemented. In any such implementation, the communication interface 818 sends and receives electrical, electromagnetic or optical signals that carry digital data streams representing various types of information.

The network link 820 typically provides data communication through one or more networks to other data devices. For example, the network link 820 may provide a connection through the local network 822 to a host computer 824 or to data equipment operated by an Internet Service Provider (ISP) 826. The ISP 826 in turn provides data communication services through the world wide packet data communication network now commonly referred to as an “Internet” 828. The local network 822 and the Internet 828 both use electrical, electromagnetic or optical signals that carry digital data streams. The signals through the various networks and the signals on the network link 820 and through the communication interface 818, which carry the digital data to and from the computer system 800, are example forms of transmission media.

The computer system 800 may send messages and receive data, including program code, through the network(s), the network link 820 and the communication interface 818. In the Internet example, a server 830 might transmit a requested code for an application program through the internet 828, The ISP 826, the local network 822 and communication interface 818. The received code may be executed by the processor 804 as it is received, and/or stored in the storage device 810, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods may be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Further aspects of the invention are provided by one or more of the following example embodiments:

In a 1st Example, an obstruction management avoidance system for an access point of a secured area, the system comprising: an optical rangefinder configured to determine distances of objects from the optical rangefinder, wherein the optical rangefinder is positioned to obtain the distances for the objects at the access point for the secured area; and a controller configured to execute instructions that cause the system to: obtain, from the optical rangefinder, a distance from the optical rangefinder to a first object at the access point; transmit, to a moveable barrier operator for controlling a moveable barrier configured to manage access to the secured area, at least one of: the distance; a control instruction for controlling a moveable barrier; or an indication that the distance falls within a target range of distances associated with the secured area; and generate, based on transmitting the at least one of the distance, the control instruction, or the indication, an instruction for modifying a state of the moveable barrier.

In a 2nd Example, the system of Example 1, wherein the instructions, when executed by the controller, cause the system further to: determine that the distance falls within the target range of distances associated with the secured area.

In a 3rd Example, the system of Example 2, wherein the instructions, when executed by the controller, cause the system further to: obtain, from the optical rangefinder, a second distance from the optical rangefinder to a second object at the access point; and determine that the second distance falls within a second target range of distances associated with the secured area.

In a 4th Example, the system of Example 3, wherein the instructions, when executed by the controller, cause the system further to: determine, based on the determination that the second distance falls within the second target range of distances, that a current state of the moveable barrier should be maintained.

In a 5th Example, the system of Example 3, wherein the instructions, when executed by the controller, cause the system further to: based on the determination that the second distance falls within the second target range of distances, transmit, to a second moveable barrier operator for controlling a second moveable barrier configured to manage access to the secured area, at least one of: the second distance; a second control instruction; or a second indication that the second distance falls within the second target range of distances associated with the secured area; and generate, based on transmitting the at least one of the second distance, the second control instruction, or the second indication, instructions for modifying a state of the second moveable barrier.

In a 6th Example, the system of Example 5, wherein the second moveable barrier is configured to manage access to the secured area, and wherein the second target range of distances is associated with the secured area.

In a 7th Example, the system of any of Examples 1-6, wherein obtaining the distance from the optical rangefinder to the first object at the access point comprises obtaining a plurality of distances from the optical rangefinder of the first object at the access point.

In a 8th Example, the system of Example 7, wherein the instructions, when executed by the controller, cause the system further to: determine, based on the plurality of distances, a length of time for which the first object is at the distance from the optical rangefinder.

In a 9th Example, the system of Example 8, wherein the instructions, when executed by the controller, cause the system further to: determine that the length of time exceeds a threshold duration; and generate, based on determining that the length of time exceeds a threshold duration, alert data configured to indicate that the length of time exceeds the threshold duration.

In a 10th Example, the system of any of Examples 1-9, wherein obtaining the distance from the optical rangefinder to the first object at the access point comprises determining that the first object intersects a beam of the optical rangefinder.

In a 11th Example, the system of Example 10, wherein the beam of the optical rangefinder has a beam divergence of less than 1 degree.

In a 12th Example, the system of Example 10, wherein the instructions, when executed by the controller, cause the system further to: determine a characteristic of the first object, wherein the characteristic comprises at least one of: a color of the first object, a time of day associated with the first object intersecting the beam of the optical rangefinder, or a duration associated with how long the first object intersects the beam of the optical rangefinder; and determine, based on the characteristic, that the first object is not expected to intersect the beam of the optical rangefinder.

In a 13th Example, the system of Example 12, wherein generating the instruction for modifying the state of the moveable barrier is further based on the determination that the first object is not expected to intersect the beam of the optical rangefinder.

In a 14th Example, the system of any of Examples 10-13, wherein the optical rangefinder is configured to output the beam parallel to a ground.

In a 15th Example, the system of any of Examples 1-14, wherein the moveable barrier operator comprises a garage door opener, and wherein the moveable barrier comprises a garage door.

In a 16th Example, a method for managing obstruction detection for an access point of a secured area, the method comprising: obtaining, from an optical rangefinder, a distance from the optical rangefinder to a first object at the access point; transmitting, to a moveable barrier operator for controlling a moveable barrier configured to manage access to the secured area, the distance; and generating, based on transmitting the distance, an instruction for modifying a state of the moveable barrier.

In a 17th Example, the method of Example 16, further comprising: determining that the distance falls within a target range of distances associated with the secured area; obtain, from the optical rangefinder, a second distance from the optical rangefinder to a second object at the access point; and determine that the second distance falls within a second target range of distances associated with the secured area; and determining, based on the determination that the second distance falls within the second target range of distances, that a current state of the moveable barrier should be maintained.

In a 18th Example, the method of Example 17, further comprising: based on the determination that the second distance falls within the second target range of distances, transmitting, to a second moveable barrier operator for controlling a second moveable barrier configured to manage access to the secured area, the second distance; and generating, based on transmitting the at least one of the second distance or the second indication, instructions for modifying a state of the second moveable barrier.

In a 19th Example, the method of any of Examples 16-18, wherein obtaining the distance from the optical rangefinder to the first object at the access point comprises determining that the first object intersects a beam of the optical rangefinder.

In a 20th Example, a non-transitory computer-readable medium storing instructions which, when executed by a hardware processor, are configured to: obtain, from an optical rangefinder, a plurality of distances from the optical rangefinder to a first object at an access point; determine, based on the plurality of distances, a length of time for which the first object is at the distance from the optical rangefinder; determine that the length of time exceeds a threshold duration; determining that the first object intersects a beam of the optical rangefinder; transmit, to a moveable barrier operator for controlling a moveable barrier configured to manage access to a secured area, an indication of one or more of the plurality of distances and the length of time; determine that the distance falls within a target range of distances associated with the secured area; and generate, based on determining that the first object intersects a beam of the optical rangefinder and that the distance falls within a target range of distances associated with the secured area, an instruction for modifying a state of the moveable barrier.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. An obstruction avoidance system for an access point of a secured area, the system comprising:
an optical rangefinder configured to determine distances of objects from the optical rangefinder, wherein the optical rangefinder is positioned to obtain the distances for the objects at the access point for the secured area; and
a controller configured to execute instructions that cause the system to:
obtain, from the optical rangefinder, a distance from the optical rangefinder to a first object at the access point;
transmit, to a moveable barrier operator for controlling a moveable barrier configured to manage access to the secured area, at least one of:
the distance;
a control instruction for controlling a moveable barrier; or
an indication that the distance falls within a target range of distances associated with the secured area; and
generate, based on transmitting the at least one of the distance, the control instruction, or the indication, an instruction for modifying a state of the moveable barrier.

2. The system of claim 1, wherein the instructions, when executed by the controller, cause the system further to:
determine that the distance falls within the target range of distances associated with the secured area.

3. The system of claim 2, wherein the instructions, when executed by the controller, cause the system further to:
obtain, from the optical rangefinder, a second distance from the optical rangefinder to a second object at the access point; and
determine that the second distance falls within a second target range of distances associated with the secured area.

4. The system of claim 3, wherein the instructions, when executed by the controller, cause the system further to:
determine, based on the determination that the second distance falls within the second target range of distances, that a current state of the moveable barrier should be maintained.

5. The system of claim 3, wherein the instructions, when executed by the controller, cause the system further to:
based on the determination that the second distance falls within the second target range of distances, transmit, to a second moveable barrier operator for controlling a second moveable barrier configured to manage access to the secured area, at least one of:
the second distance;
a second control instruction; or
a second indication that the second distance falls within the second target range of distances associated with the secured area; and
generate, based on transmitting the at least one of the second distance, the second control instruction, or the second indication, instructions for modifying a state of the second moveable barrier.

6. The system of claim 5, wherein the second moveable barrier is configured to manage access to the secured area, and wherein the second target range of distances is associated with the secured area.

7. The system of claim 1, wherein obtaining the distance from the optical rangefinder to the first object at the access point comprises obtaining a plurality of distances from the optical rangefinder of the first object at the access point.

8. The system of claim 7, wherein the instructions, when executed by the controller, cause the system further to:
determine, based on the plurality of distances, a length of time for which the first object is at the distance from the optical rangefinder.

9. The system of claim 8, wherein the instructions, when executed by the controller, cause the system further to:
determine that the length of time exceeds a threshold duration; and
generate, based on determining that the length of time exceeds a threshold duration, alert data configured to indicate that the length of time exceeds the threshold duration.

10. The system of claim 1, wherein obtaining the distance from the optical rangefinder to the first object at the access point comprises determining that the first object intersects a beam of the optical rangefinder.

11. The system of claim 10, wherein the beam of the optical rangefinder has a beam divergence of less than 1 degree.

12. The system of claim 10, wherein the instructions, when executed by the controller, cause the system further to:
determine a characteristic of the first object, wherein the characteristic comprises at least one of: a color of the first object, a time of day associated with the first object intersecting the beam of the optical rangefinder, or a duration associated with how long the first object intersects the beam of the optical rangefinder; and
determine, based on the characteristic, that the first object is not expected to intersect the beam of the optical rangefinder.

13. The system of claim 12, wherein generating the instruction for modifying the state of the moveable barrier is further based on the determination that the first object is not expected to intersect the beam of the optical rangefinder.

14. The system of claim 10, wherein the optical rangefinder is configured to output the beam parallel to a ground.

15. The system of claim 1, wherein the moveable barrier operator comprises a garage door opener, and wherein the moveable barrier comprises a garage door.

16. A method for managing obstruction detection for an access point of a secured area, the method comprising:
obtaining, from an optical rangefinder, a distance from the optical rangefinder to a first object at the access point;
transmitting, to a moveable barrier operator for controlling a moveable barrier configured to manage access to the secured area, the distance; and
generating, based on transmitting the distance, an instruction for modifying a state of the moveable barrier.

17. The method of claim 16, further comprising:
determining that the distance falls within a target range of distances associated with the secured area;
obtain, from the optical rangefinder, a second distance from the optical rangefinder to a second object at the access point; and
determine that the second distance falls within a second target range of distances associated with the secured area; and
determining, based on the determination that the second distance falls within the second target range of distances, that a current state of the moveable barrier should be maintained.

18. The method of claim 17, further comprising:
based on the determination that the second distance falls within the second target range of distances, transmitting, to a second moveable barrier operator for controlling a second moveable barrier configured to manage access to the secured area, the second distance; and
generating, based on transmitting the at least one of the second distance or the second indication, instructions for modifying a state of the second moveable barrier.

19. The method of claim 16, wherein obtaining the distance from the optical rangefinder to the first object at the access point comprises determining that the first object intersects a beam of the optical rangefinder.

20. A non-transitory computer-readable medium storing instructions which, when executed by a hardware processor, are configured to:
obtain, from an optical rangefinder, a plurality of distances from the optical rangefinder to a first object at an access point;
determine, based on the plurality of distances, a length of time for which the first object is at the distance from the optical rangefinder;
determine that the length of time exceeds a threshold duration;
determining that the first object intersects a beam of the optical rangefinder;
transmit, to a moveable barrier operator for controlling a moveable barrier configured to manage access to a secured area, an indication of one or more of the plurality of distances and the length of time;
determine that the distance falls within a target range of distances associated with the secured area; and
generate, based on determining that the first object intersects a beam of the optical rangefinder and that the distance falls within a target range of distances associated with the secured area, an instruction for modifying a state of the moveable barrier.
